(19) United States
(12) Patent Application Publication
(10) Pub. No.: US 2001/0017203 A1
(43) Pub. Date: Aug. 30, 2001

(54) Automotive air-conditioner having scroll casing

(76) Inventors: Yukio Uemura, Nagoya-city (JP); Masafumi Kawashima, Kariya-city (JP); Koji Ito, Nagoya-city (JP)

Correspondence Address: HARNESS, DICKEY & PIERCE, PLC, 5445 CORPORATE DRIVE, SUITE 400, TROY, MI, 48098, US

(21) Appl. No.: 09/792,927

(22) Filed: Feb. 26, 2001

(30) Foreign Application Priority Data
Feb. 28, 2000 (JP) 2000-56053
Dec. 26, 2000 (JP) 2000-395523

(51) Int. Cl. B60H 3/00; B61D 27/00; F24B 1/06; F28F 13/12; F28F 1/00; F25B 29/00

(52) U.S. Cl. 165/201; 165/42; 165/43; 165/125

(57) ABSTRACT

An automotive air-conditioner unit which is thin and suitable for use as a rear seat unit is composed of a blower unit with a centrifugal fan and a scroll casing, heat-exchanges for cooling and heating, and conditioned air outlets, all contained in an air-conditioner case. A backward centrifugal fan having a large blade angle is used in combination with a scroll casing having a small scroll angle to obtain high fan efficiency in the compact air-conditioner unit. An outlet duct requiring a higher volume of conditioned air is positioned closer to a scroll-starting position of the scroll casing than another outlet duct requiring a less volume. An air passage in the air-conditioner case is formed along a surface perpendicular to a rotational axis of the fan to reduce a pressure loss in the passage.

### CROSS-REFERENCE TO RELATED APPLICATIONS

This application is based upon and claims benefit of priority of Japanese Patent Applications No. 2000-56053 filed on Feb. 28, 2000 and No. 2000-395523 filed on Dec. 26, 2000, the contents of which are incorporated herein by reference.

### BACKGROUND OF THE INVENTION

1. Field of the Invention

The present invention relates to an automotive air-conditioner that includes a centrifugal fan and a scroll casing, and more particularly to such an air-conditioner which is suitable as a rear seat air-conditioner in an one-box vehicle such as a recreational vehicle.

2. Description of Related Art

Since a rear seat automotive air-conditioner is usually disposed in a body wall between an outside plate and an inside trim plate, it is required to make the air-conditioner thin and compact. Also, a thin and compact air-conditioner is required when it is disposed in a small space at a front seat side. A centrifugal fan supplying a large amount of air is usually used together with a scroll casing for quickly air-conditioning a passenger compartment. However, it has been difficult to make such an air-conditioner compact because a large space is required for the scroll casing.

To make the scroll casing smaller, it is effective to reduce a scroll angle of the scroll casing. In this direction, various proposals have been made, for example, in disclosures of JP-A-60-159351, JP-A-9-145147 and JP-U-62-83112. However, those conventional air-conditioners do not employ air-outlets which are selectively switched according to desired air-condition modes. It is especially important in an automotive air-conditioner to provide plural air-outlets which can be selectively used according to air-conditioning modes desired by passengers. It is also important to be able to blow a large amount of air from a particular air-outlet while blowing a smaller amount of air from another air-outlet.

### SUMMARY OF THE INVENTION

The present invention has been made in view of the above-mentioned problem, and an object of the present invention is to provide an improved automotive air-conditioner which is compact in size and is able to supply a large amount of air to a particular air-outlet.

The air-conditioner unit of the present invention is composed of a blower unit that includes a centrifugal fan and a scroll casing, an evaporator for cooling and a heater core, all of those components being disposed in an air-conditioner case. The air-conditioner unit is made thin and compact so that it can be easily installed in a narrow space such as a wall of a vehicle body close to the rear seats.

It is advantageous to use a scroll casing that has a small scroll angle to reduce the size of the air-conditioner unit. However, fan efficiency becomes low if the scroll casing having a small scroll angle (for example, 210°) is used together with a usual forward fan that has a blade angle smaller than 90°. In order to compensate the efficiency decrease associated with the scroll casing having a small scroll angle, a backward fan having a blade angle larger than 90° (for example, 135°) is used in the present invention.

In an automotive air-conditioner, it is required to blow a higher volume of conditioned air from a face-duct under a face-mode than from a foot-duct under a foot-mode. It is found out that a higher air volume is obtained from an outlet positioned closer to a scroll-starting position in the scroll casing having a small scroll angle than from another outlet positioned far from the scroll-starting position. Therefore, the face-duct is positioned closer to the scroll-starting position than the foot-duct in the air-conditioner unit of the present invention.

An air passage through the centrifugal fan, the scroll casing, the evaporator, the heater core and the outlet ducts is formed in the air-conditioner case along a surface perpendicular to a rotational axis of the centrifugal fan. In this manner, pressure loss in the air passage formed in the thin case is minimized.

Temperature of the conditioned air is controlled by mixing air cooled through the evaporator with air re-heated through the heater core. Alternatively, an amount of hot water supplied to the heater core is controlled. The face-mode under which conditioned air is supplied to a head portion of passengers and the foot-mode under which conditioned air is supplied to a foot portion of passengers are selectively switched by opening or closing respective outlet ducts. The evaporator is positioned along an outer periphery of the centrifugal fan to save the space and to increase the fan efficiency. The evaporator may be formed in an arcuate shape, or divided into plural rectangular boxes.

According to the present invention, a thin and compact air-conditioner unit that is able to blow a high amount of conditioned air from the face-duct with a high efficiency is realized.

Other objects and features of the present invention will become more readily apparent from a better understanding of the preferred embodiments described below with reference to the following drawings.

### BRIEF DESCRIPTION OF THE DRAWINGS

FIG. 1 is a perspective view showing a vehicle on which a rear seat air-conditioner according to the present invention is mounted;

FIG. 2 is a cross-sectional view showing a rear seat air-conditioner unit as a first embodiment of the present invention;

FIG. 3 is a cross-sectional view showing the air-conditioner unit, taken along a line III-III in FIG. 2;

FIG. 4 is a plan view showing the air-conditioner unit, viewed in a direction B shown in FIG. 2;

FIG. 5 is a schematic cross-sectional view showing a part of a cooling heat exchanger used in the air-conditioner unit, viewed in a direction D shown in FIG. 2;

FIG. 6 is a schematic view showing a centrifugal fan and a scroll casing used in the air-conditioner unit shown in FIG. 2;

FIG. 7 is a diagram showing airflow components in the scroll casing;

FIG. 8 is a cross-sectional view showing an air-conditioner unit as a second embodiment of the present invention;

FIG. 9 is a cross-sectional view showing an air-conditioner. unit as a third embodiment of the present invention;

FIG. 10 is a schematic view showing a part of an air-conditioner unit made as a proto-type;

FIG. 11 is a graph showing a relation between air volume and total fan pressure as test results of the prototype shown in FIG. 10; and

FIG. 12 is a graph showing a relation between scroll angle and fan efficiency.

### DETAILED DESCRIPTION OF THE PREFERRED EMBODIMENTS

(Proto-type Sample)

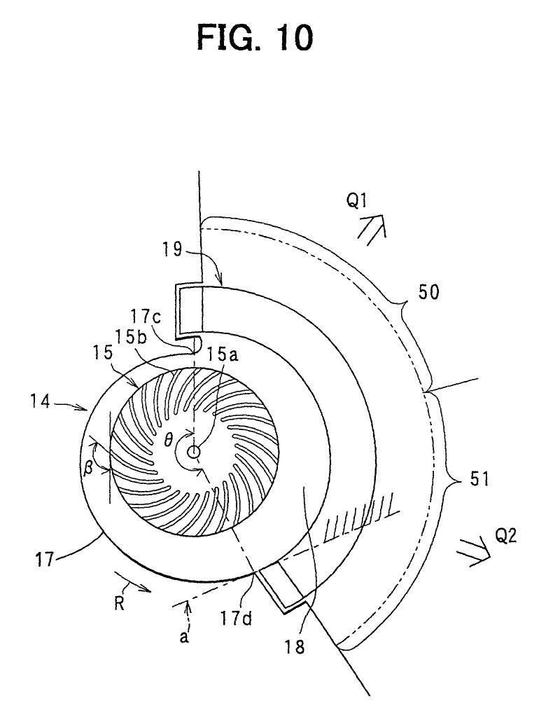

Applicants made a proto-type air-conditioner unit having two air-outlets which are selectively used and a scroll casing with a small scroll angle θ. FIG. 10 shows a main portion of the proto-type. An arcuate heat exchanger 19 for cooling is disposed outside a blower 14 composed of a centrifugal fan 15 fixed to a rotational axis 15a and a scroll casing 17 disposed around the fan 15. The centrifugal fan 15 is a so-called backward fan (explained below) having plural blades 15b. The scroll angle θ of the scroll casing 17 is set to 210°. The scroll angle θ is measured from a scroll-starting portion 17c where the scroll begins to a scroll-ending portion 17d where the scroll ends, as shown in FIG. 10. A first opening 50 is disposed upward (closer to the scroll-starting portion) and a second opening 51 is disposed downward (closer to the scroll-ending portion), as shown in FIG. 10.

When the fan 15 rotates in a direction R, air is blown toward the heat exchanger 19 through an outlet air passage 18 formed in the scroll casing 17. Air cooled by the heat exchanger 19 is blown to the first opening 50 and the second opening 51 which are selectively or simultaneously opened. The first opening 50 is supposed to be connected to a face-duct that supplies conditioned air to a head portion of a passenger, while the second opening is supposed to be connected to a foot-duct that supplies conditioned air to a foot portion of the passenger. Usually, a higher air volume is required for the face-duct than for the foot-duct in an automotive air-conditioner.

There are two types of centrifugal fans. One is a forward fan (sirocco-fan) that has a blade angle β smaller than 90°, and the other is a backward fan (turbo-fan) that has a blade angle β larger than 90°. The blade angle β is defined as an angle between a tangent line at a peripheral point of the fan and a blade direction at that peripheral point, as illustrated in FIG. 10. FIG. 12 shows fan efficiency η_{f} versus the scroll angle θ for both the forward fan and the backward fan. As seen in the graph of FIG. 12, the forward fan shows a high efficiency in a region where the scroll angle θ is large (about 290°-330°), while the backward fan shows a relatively flat characteristic in the efficiency and shows a relatively high efficiency in a region where the scroll angle θ is small (smaller than 290°). It is effective to make the scroll angle smaller to reduce the size of the scroll casing. Therefore, the scroll casing having a small scroll angle is used in combination with the backward fan in the proto-type.

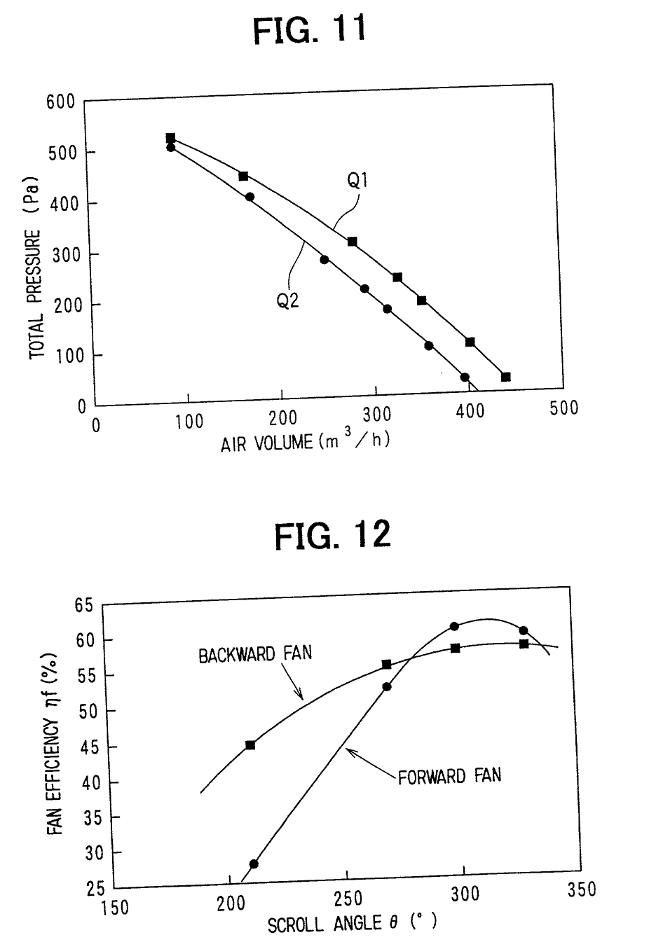

FIG. 11 shows test results of the proto-type described above. Air volume flowing out of the first and the second openings 50, 51 is plotted in the abscissa versus total fan pressure in the ordinate. Q1 shows the air volume flowing out of the first opening 50 when the second opening 51 is closed, while Q2 shows the air volume flowing out of the second opening 51 when the first opening 50 is closed. As seen in the graph, at the total fan pressure 300 Pa, Q1 is about 280 m³/h, and Q2 is about 230 m³/h. It is found out that the air volume flowing out of the openings considerably depends on the position of the openings relative to the scroll-starting portion 17c and the scroll-ending portion 17d, when a scroll casing 17 having a small scroll angle θ is used.

(First Embodiment)

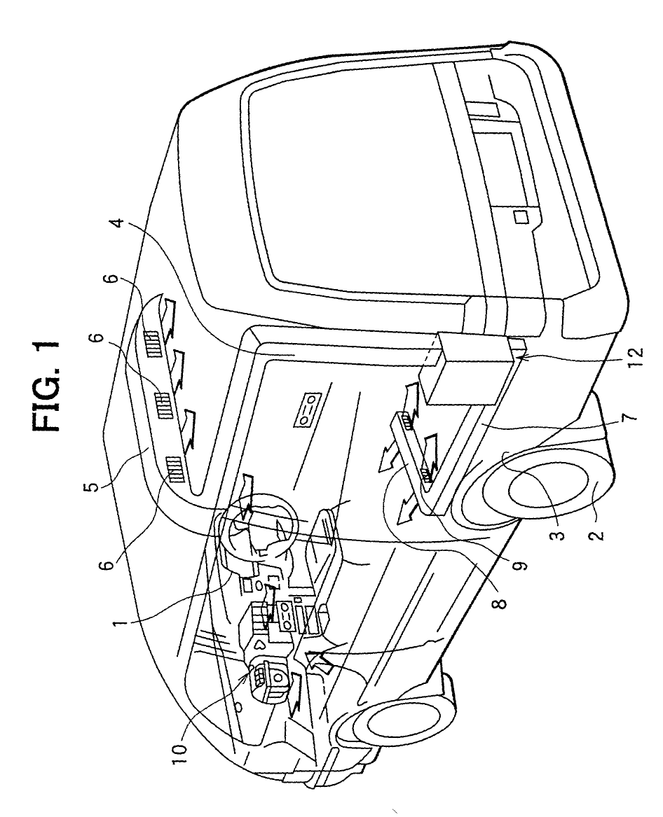

Now, a first embodiment of the present invention will be described with reference to FIGS. 1 to 7. FIG. 1 shows an one-box-type recreational vehicle on which an air-conditioner of the present invention is mounted. A front seat air-conditioner unit 10 for air-conditioning a front passenger space is disposed inside an instrument panel 1. The front seat air-conditioner unit 10 is composed of: a blower unit having a box for switching outside air and inside air and a centrifugal fan; and an air-conditioner unit having a heat exchanger for cooling (evaporator) that cools air by evaporating refrigerant in a refrigerating cycle and a heater core that heats air by heat of engine cooling water.

A rear seat air-conditioner unit 12 for air-conditioning a rear passenger space is disposed at a side of rear seats. More particularly, the rear seat air-conditioning unit 12 is disposed inside a vehicle wall positioned behind a tire housing 3 covering a tire 2, as shown in FIG. 1. Air conditioned by the unit 12 is blown from foot-outlets 9 through foot-ducts 7, 8 and from face outlets 6 disposed on the ceiling through face-ducts 4, 5.

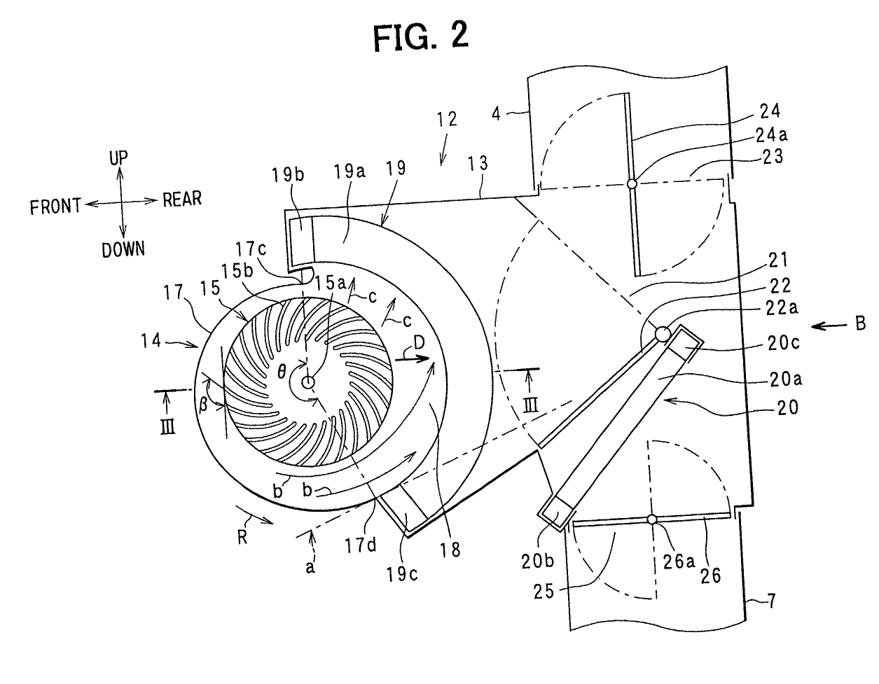

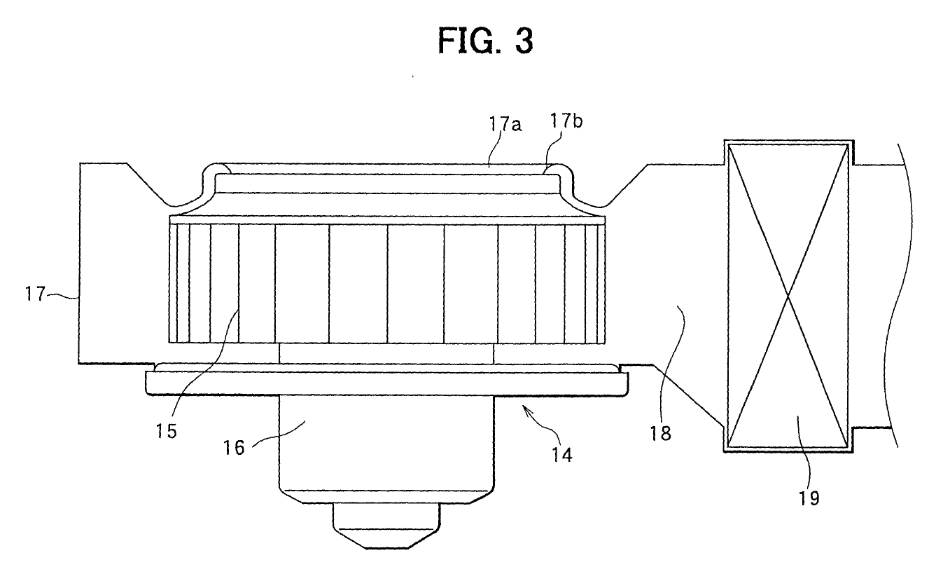

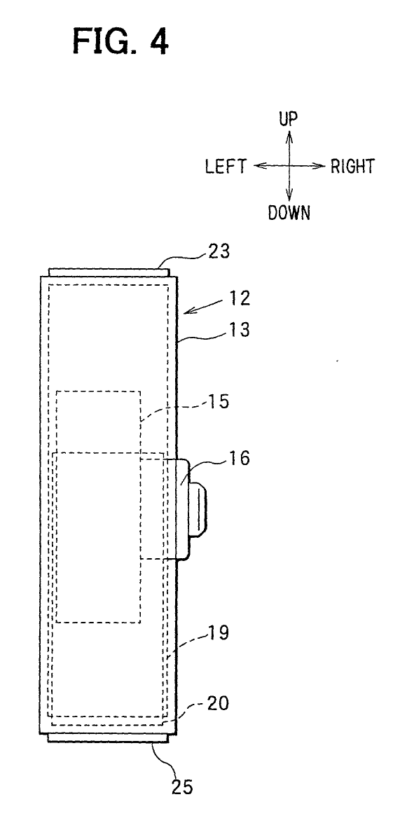

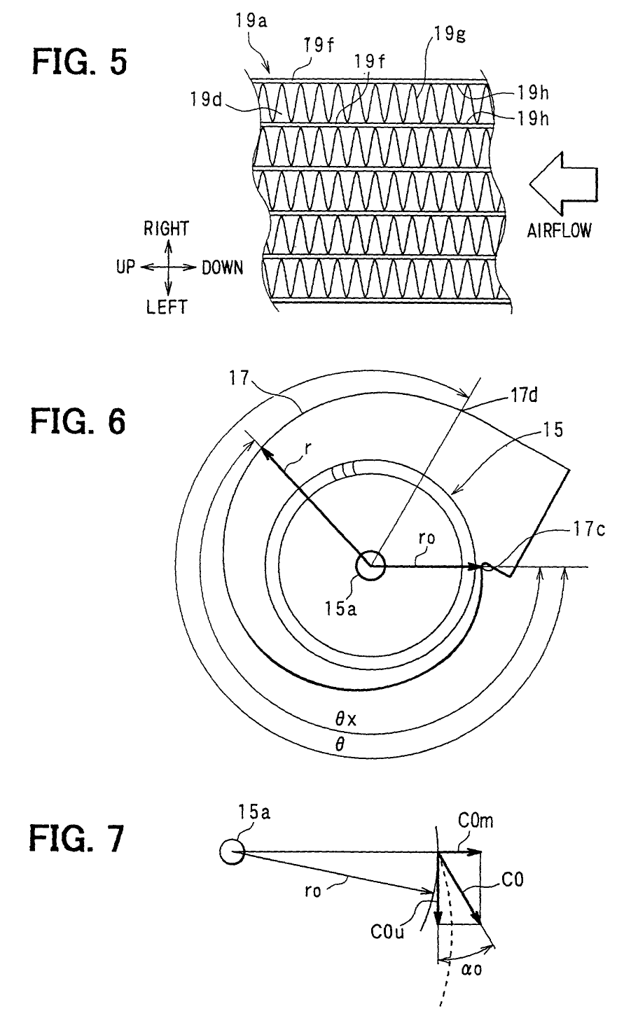

Referring to FIGS. 2-7, the rear seat air-conditioner unit 12 will be described in detail. FIG. 2 is a cross-sectional view showing the unit 12, the unit 12 being cut out along a vertical plane in the front to rear direction. FIG. 3 is a cross-sectional view showing the unit 12, taken along line III-III shown in FIG. 2. FIG. 4 is a rear view of the unit 12, viewed in the direction B shown in FIG. 2. FIG. 5 shows a portion of a heat exchanger 19, viewed in direction D shown in FIG. 2. FIG. 6 is a drawing for explaining a shape of a scroll casing 17, and FIG. 7 is a diagram for explaining a scroll-spreading angle α₀.

The following description will be made mostly with reference to FIG. 2, also referring to other drawings when necessary. Components of the unit 12 are contained in an air-conditioner case 13 made of resin such as polypropylene. The case 13 is formed by connecting plural case components. The unit 12 is formed in a shape of a thin rectangular box as a whole, as shown in FIG. 4, because it is disposed in a vehicle sidewall. A blower 14 is contained in the case 13 at its front portion. The blower 14 is composed of a centrifugal fan 15 having plural blades 15b, a motor 16 for driving the fan 15 and a scroll casing 17.

The motor 16 is firmly connected to and held by the scroll casing 17 through a fixing member (not shown). The fan 15 is rotated by the rotational axis 15a in the direction R shown in FIG. 2. The fan 15 sucks air in its axial direction and blows air in its radial direction which is perpendicular to the axial direction. The centrifugal fan 15 used in this embodiment is the backward fan explained above, and the blade angle β is set to 135°. The scroll casing 17 is formed in a shape of a scroll and contains the fan 15 therein. The scroll casing 17 also forms an outlet air passage 18. An air inlet 17a having a surrounding bell mouth 17b is formed at one axial side of the scroll casing 17, as shown in FIG. 3.

The shape of the scroll in the scroll casing 17 will be explained with reference to FIGS. 6 and 7. A distance r between the center of axis 15a and inner wall of the scroll casing 17 is expressed in the following formula:

r=r₀·exp(θₓ·tan α₀),

where r₀ is a distance between the center of the axis 15a and the inner wall of the scroll casing 17 at the scroll-starting portion 17c (also referred to as a nose portion); θₓ is an angle at a position of r measured from the scroll-starting portion 17c; and α₀ is a scroll-spreading angle expressed in the following formula:

α₀=tan⁻¹(Com/Cou),

where Com is a radial component of an airflow speed Co generated by the fan 15, and Cou is a component in the rotational direction of the airflow speed Co, as illustrated in FIG. 7. The distance r takes the smallest value r₀ at the scroll-starting portion 17c, and the scroll-ending portion 17d is defined as a position where the distance between the center of axis 15a and the inner wall of the scroll casing 17 becomes larger than (0.9-1.1)·r, where r is a value calculated according to the formula above. The scroll angle θ is defined as the angle between the scroll-starting portion 17c and the scroll-ending portion 17d. The scroll angle θ is set to 210° in this embodiment.

The outlet air passage 18 is formed downstream of the scroll angle θ, and an evaporator 19 (a heat exchanger for cooling) is disposed in the outlet air passage 18. The evaporator 19 cools air by evaporating refrigerant supplied from the refrigerating cycle in the front seat air-conditioner unit 10 through an expansion valve (not shown). As shown in FIG. 2, the evaporator 19 is composed of a heat exchanger portion 19a and a first tank 19b and a second tank 19c.

The heat exchanger portion 19a, as shown in FIG. 5, is composed of plural flat tubes 19f and corrugated fins 19g disposed between the flat tubes 19f. The flat tubes 19f and the corrugated fins 19g are alternately laminated and connected to one another. The tubes 19f and the corrugated fins 19g are made of a corrosion-resistive material having high heat conductivity such as an aluminum alloy. The heat exchanger portion 19a is formed into an arcuate shape so that it is disposed circularly along the scroll casing 17. The heat exchanger portion 19a is disposed, so that flat surfaces 19h of the tubes 19f are placed substantially in parallel to a plane perpendicular to the rotational axis 15a of the fan 15.

The heat exchange portion 19a is divided into plural spaces by plural tubes 19f, and the space between neighboring tubes forms a main air passage 19d. The corrugated fin 19gis disposed in the main air passage 19d and soldered to the flat surfaces 19h of the tubes 19f. Plural louvers (not shown) for expediting heat exchange are formed in the corrugated fins 19g, and air is able to pass through the corrugated fins 19g. As shown in FIG. 2, the first tank 19b connected to the plural tubes 19f is disposed at a position close to the scroll-starting position 17c located at the upper portion of the unit 12, and the second tank 19c connected to the plural tubes 19f is disposed at a position close to the scroll-ending position 17d located at the lower portion of the unit 12. A refrigerant inlet port (not shown) from which the refrigerant is supplied and a refrigerant outlet port (not shown) are formed in the first tank 19b.

The refrigerant in a vapor-liquid-mixed phase decompressed through the expansion valve enters the first tank 19b and is vaporized through the heat exchanger portion 19a. The refrigerant makes a U-turn in the second tank 19c, and the vaporized refrigerant flows out from the first tank 19b. Air blown by the fan 15 flows into the heat exchanger 19 disposed in the outlet air passage 18, and thereby the air is cooled down through the heat exchanger 19.

As shown in FIG. 2, a heater core 20 is disposed downstream of the evaporator 19 in the air-conditioner case 13. The heater core 20 is composed of a heat exchanging portion 20a having alternately laminated flat tubes and corrugated fins, and a pair of tanks 20b, 20c connected to both ends of the heat exchanging portion 20a. The hearer core 20 is contained in the air-conditioner case 13 with a slanted angle, placing one tank 20c upward and the other tank 20b downward. Hot water supplied from an engine to the downward tank 20b flows through the tubes in the heat exchanger portion 20a and flows out from-the upward tank 20c.

A cool air passage 21 bypassing the heater core 20 is formed in the air-conditioner case 13 at a position above the heater core 20. An air-mix door 22 is disposed in front of the heater core 20. The air-mix door 22 controls air temperature by mixing cool air flowing through the cool air passage 21 and hot air passing through the heater core 20 in a controlled manner. The air-mix door 22 is plate-shaped and pivotally rotated around an axis 22a. The air-mix door position shown in FIG. 2 is a position for supplying the maximum amount of cooled air, and the position shown with a dotted line is a position for supplying the maximum amount of heated air. The cooled air and the hot air are mixed in a arbitrary ratio according to positions of the air-mix door 22.

A face-duct opening 23 connected to the face duct 4 is formed at an upper portion of the air-conditioner case 13. Conditioned air to be blown toward a head portion of passengers flows out through the face-duct opening 23. The face-duct opening 23 is opened or closed by a face-duct door 24 rotating around its axis 24a. A foot-duct opening 25 connected to the foot-duct 7 is formed at a downward portion of the air-conditioner case 13. Conditioned air to be blown toward a foot portion of passengers flows out through the foot-duct opening 25. The foot-duct opening 25 is opened or closed by a foot-duct door 26 rotating around its axis 26a. The face-door position shown in FIG. 2 is a fully open position, and its position shown with a dotted line is a fully closed position. The foot-door position shown in FIG. 2 is a fully closed position, and its position shown with a dotted line is a fully open position. By controlling the face-door 24 and the foot-door 26 into intermediate positions, a bi-level mode in which conditioned air is blown toward both positions of the passengers, the face and the foot positions can be set.

As shown in FIG. 1, the conditioned air flowing out through the face-duct opening 23 is led to the face-outlets 6 disposed in the ceiling of the vehicle, while the conditioned air flowing out through the foot-duct opening 25 is led to the foot-outlets 9 disposed at the foot position of the passengers. The conditioned air flowing out of the foot-outlets 9 is blown into both directions, forward and backward.

The airflow passage formed in the air-conditioner case 13 extends in a direction perpendicular to the longitudinal direction of the fan axis 15a throughout its whole path from the scroll casing 17 to the face-duct opening 23 and the foot-duct opening 25. In other words, the evaporator 19, the heater core 20 and both openings 23, 25 are arranged in the airflow direction which is perpendicular to the fan axis 15a. Both openings 23, 25 take offset positions with respect to the fan axis 15a. That is, the face-duct opening 23 is positioned upward and closer to the scroll-starting position 17c, while the foot-duct opening 25 is positioned downward and closer to the scroll-ending position 17d. In other words, the face-duct opening 23 is positioned upward with respect to a tangent line “a” extending from the scroll-ending position 17, while the foot-duct opening 25 is positioned downward with respect to the same tangent line “a”.

Now, operation of the air-conditioner unit 12 will be described. When the fan 15 is driven by the motor 16, air inside the passenger compartment is sucked by the fan 15. The sucked air is blown into the scroll casing 17 in the direction of arrows “b” shown in FIG. 2. The air blown into the scroll casing 17 within the range of the scroll angle θ is rectified therein and flows out into the outlet air passage 18. The airflow “lb” at a vicinity of the scroll-ending position 17d is directed in a direction substantially parallel to the tangent line “a”, somewhat curving upwardly. Therefore, the air flows from the bottom of the evaporator 19 toward the center thereof. Airflow “c” directly blown to the outlet portion of the scroll casing 17 is directed toward the upper portion of the evaporator 19.

The air supplied to the evaporator 19 is cooled down therein. When the air-mix door 22 is in an intermediate position, a part of the cooled air flows through the cool air passage 21, while the other part of the cooled air flows through the heater core 20 and is heated. By controlling the air-mix door position, the mixing ratio of the cooled air and heated air is controlled. Thus, the temperature of air to be supplied to the passenger compartment is adjusted.

When the face-duct opening 23 is fully open and the foot-duct 25 is fully closed, as shown in FIG. 2, a face-mode, in which conditioned air is supplied only to the head portion of passengers, is set. Under the face-mode, when the maximum cooling is required, e.g., to quickly cool down the compartment after parking under a high temperature, the air-mix door 22 is controlled to a position to fully open the cool air passage 21. On the other hand, when the face-duct opening 23 is fully closed and the foot-duct opening 25 is fully opened, as shown with dotted lines in FIG. 2, a foot-mode, in which conditioned air is supplied only to the foot portion of passengers, is set. Under the foot-mode, when the maximum heating is required, the air-mix door 22 is controlled to a position to fully close the cool air passage 21.

When both openings 23, 25 are half opened, a bi-level mode, in which conditioned air is supplied both to the head portion and foot portion of passengers, is set.

Advantageous features of the first embodiment will be explained below. When the scroll angle θ is large (e.g., 310°), the outlet area of the scroll casing 17 becomes small, and the air passage in a course from the small outlet to the evaporator 19 is suddenly enlarged. Accordingly, a pressure loss is caused by the sudden enlargement of the airflow passage. On the other hand, the scroll angle θ is excessively small (e.g., smaller than 180°), the airflow passage is enlarged in a wide angle at the outlet of the scroll casing 17, and the air passage in a course from the large outlet to the evaporator 19 and further to the heater core 20 is suddenly decreased. Accordingly, a pressure loss is caused by the sudden decrease of the airflow passage. To avoid such sudden changes of the airflow passage size, it is necessary to enlarge the length of the airflow passage. The longer airflow passage results in enlarging the size of the air-conditioner case 13.

When the scroll angle θ is set to about 210°, as in the embodiment described above, the outlet area of the scroll casing 17 and the airflow angle are set to a proper range. Therefore, the pressure loss problem due to the sudden changes of the airflow passage is avoided without enlarging the size of the air-conditioner unit 12.

Since the evaporator 19 is formed in an arcuate shape in the foregoing embodiment, the airflow passage in the evaporator 19 is made sufficiently large, thereby reducing the pressure loss. In addition, the evaporator 19 is disposed along the circular outer periphery of the fan 15, thereby saving the space for disposing the fan 15 and the evaporator 19 in the air-conditioner case 13.

Since the backward fan which shows a smaller efficiency decrease in a smaller scroll angle range is used in the foregoing embodiment, a relatively high efficiency is attained in combination with the scroll casing having a small scroll angle. If a forward fan were used together with the scroll casing having the scroll angle less than 290°, the fan efficiency would be considerably decreased. In conventional automotive air-conditioners, a forward fan is usually used in combination with a scroll casing having a scroll angle of about 310°. The amount of conditioned air volume attained in the air-conditioner according to the present invention is the same or more than that attained in the conventional air-conditioners, even through the size of the air-conditioner of the present invention is smaller than that of the conventional ones.

In the air-conditioner using the scroll casing having a small scroll angle θ, an amount of air blown from an outlet varies depending on the outlet positions relative to the scroll-stating or the scroll-ending positions. Since the face-duct opening 23 is positioned closer to the scroll-starting position 17c, while positioning the foot-duct opening 25 closer to the scroll-ending position 17d in the embodiment of the present invention, a higher amount of air is blown from the face-duct opening 23 under the face-mode than the air blown from the foot-duct opening 25 under the foot-mode. Since the face-duct opening 23 is positioned higher than the tangent line “a”, the air smoothly flows toward the face-duct opening 23. Therefore, the amount of air flowing out from the face-duct opening 23 is further increased.

In the foregoing embodiment, the air blown from the fan 15 toward the evaporator 19 flows in the surface perpendicular to the fan axis 15a, and the main air passage 19d in the evaporator 19 is also positioned substantially parallel to that surface. Therefore, the air smoothly flows through the evaporator 19, and thereby the pressure loss in the evaporator 19 is minimized. Since the first tank 19b is placed at the upward position while placing the second tank 19c at the downward position, thereby making the entire evaporator 19 thin, the width (a dimension in the right to left direction of the vehicle) of the rear seat air-conditioner unit 12 can be made small as a whole.

Since the evaporator 19 is formed into an arcuate shape after it is formed in a rectangular shape, it can be manufactured in a process common to usual rectangular evaporators. Problems such as the fan efficiency decrease and the insufficient air amount associated with use of the scroll casing having a small scroll angle θ are solved by present invention. Accordingly, the high amount of conditioned air required for the maximum cooling is obtained in the air-conditioner unit having a smaller size.

(Second Embodiment)

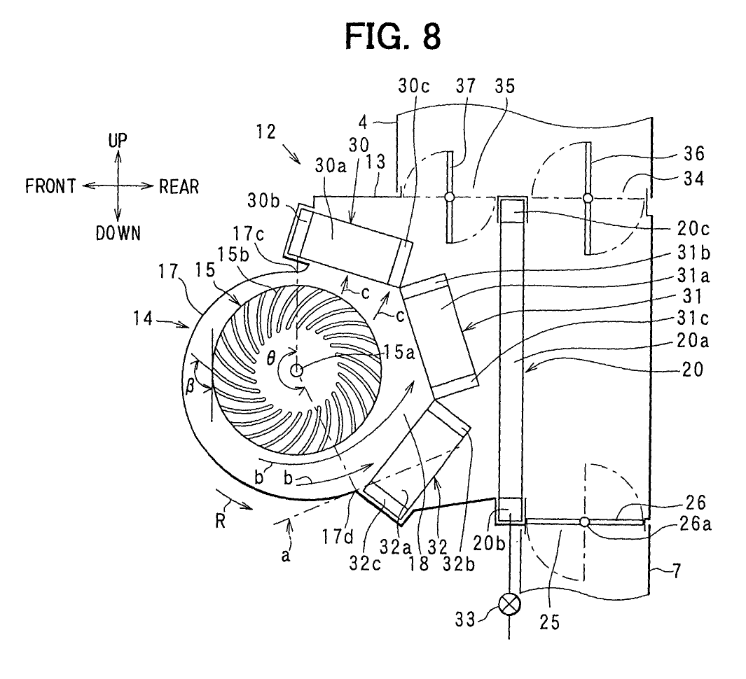

A second embodiment of the present invention will be described with reference to FIG. 8. The second embodiment is similar to the first embodiment, except that the arcuate evaporator 19 of the first embodiment is replaced with three rectangular box-shaped evaporators 30, 31, and 32, and that the heater core 20 disposed with a slanted angle in the first embodiment is disposed at an upright position in the second embodiment. The same parts and components as those in the first embodiment carry the same reference numbers, and only the structure and function different from those of the first embodiment will be described below.

A first evaporator 30 composed of a heat exchanger portion 30a, an inlet tank 30b and an outlet tank 30c; a second evaporator 31 composed of a heat exchanger portion 31a, an inlet tank 31b and an outlet tank 31c; and a third evaporator 32 composed of a heat exchanger portion 32a, an inlet tank 32b and an outlet tank 32c are positioned along the outside peripheral surface of the fan 15. Each evaporator 30, 31, 32 is shaped in a rectangular parallelepiped shape which is more easily manufactured than the arcuate evaporator.

The heater core 20 is disposed in the air-conditioner case 13 at an upright position. The air-mix door 22 used in the first embodiment is eliminated, and a hot water control valve 33 is disposed in a hot water supply passage. The temperature of air supplied to the passenger compartment is controlled and adjusted by operation of air-mix door 22 in the first embodiment. In this embodiment, however, the air temperature is controlled by changing the amount of hot water supplied to the heater core 20. The hot water enters into the lower tank 20b, flows through the heat exchanging portion 20a, and flows out from the upper tank 20c.

Two face-duct openings, a first face-duct opening 34 and a second face-duct opening 35 are formed in this embodiment. The first face-duct opening 34 is opened or closed by a first face-duct door 36, and the second face-duct opening 35 is opened or closed by a second face-duct door 37. The second face-duct opening 35 is positioned downstream of the evaporators 30, 31, 32, while the first face-duct opening 34 is positioned downstream of the heater core 20. Therefore, the air cooled by the evaporators directly flows out through the second face-duct opening 35, while the air flowing through the heater core 20 is supplied to the first face-duct opening 34.

Under the face-mode, both of the first and the second face-duct openings 34, 35 are open, and the foot-duct opening 25 is closed. Under the foot-mode, both face-duct openings 34, 35 are closed and the foot-duct opening 25 is open.

Since both of the face duct-openings 34, 35 are positioned above the tangent line “a” extending from the scroll-ending position 17d, and the foot-duct opening 25 is positioned under the same tangent line, the amount of air flown through the face-duct openings 34, 35 under the face-mode is larger than the amount of air flown through the foot-duct opening 25 under the foot-mode. The similar advantages as those of the first embodiment are obtained in this second embodiment, too.

(Third Embodiment)

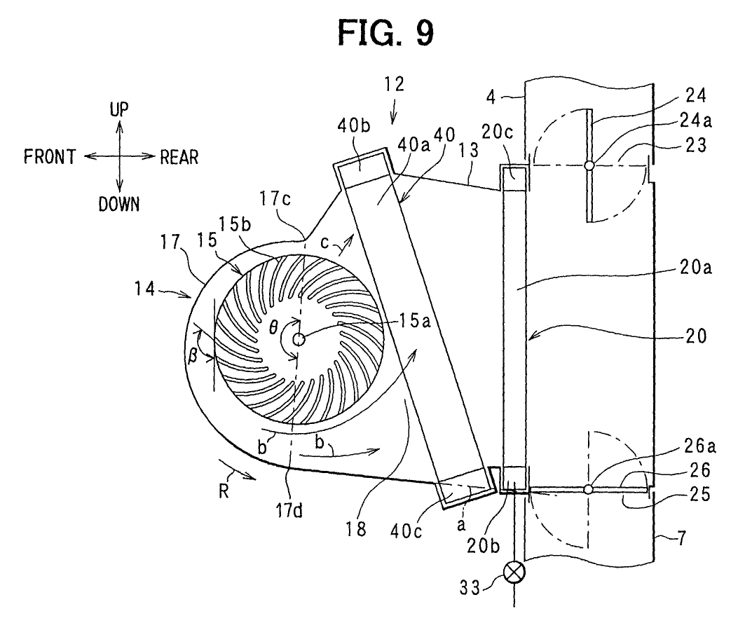

A third embodiment of the present invention will be described with reference to FIG. 9. The third embodiment is similar to the second embodiment. Therefore, only the features different from the second embodiment will be explained below. In place of the three evaporators 30, 31, 32 used in the second embodiment, a single rectangular parallelepiped evaporator 40 is used in the third embodiment. The evaporator 40, composed of a heat exchanger portion 40a, an upper tank 40b and a lower tank 40c, is disposed in the outlet air passage 18 at a slanted position, as shown in FIG. 9. Accordingly, the upper tank 40b is positioned ahead of the lower tank 40c in the front-rear direction of a vehicle.

Both of the face-duct opening 23 and the foot-duct opening 25 are positioned downstream of the heater core 20. The amount of hot water supplied to the heater core 20 is controlled by the control valve 33 in the same manner as in the second embodiment. The air cooled by the evaporator 40 flows through the heater core 20, thereby the temperature of the air supplied to the outlet ducts being properly controlled.

The scroll angle θ is set to a vicinity of 180° (not smaller than 180°) in this embodiment. Both the face-duct opening 23 and the fool-duct opening 25 are positioned above the tangent line “a” extending from the scroll-ending position 17d. The face-duct opening 23 is positioned closer to the scroll-starting position 17c than the foot-duct opening 25. Therefore, the amount of air flowing out of the face-duct opening 23 under the face-mode is larger than the amount of air flowing out of the foot-duct opening 25 under the foot-mode.

(Modifications)

Though only the rear seat air-conditioner units 12 are described as the embodiments, the present invention is similarly applicable to the front seat air-conditioner unit 10.

Though the angle of the louver formed on the corrugated fin 19g is not defined in the foregoing embodiments, the louver may be formed, so that it becomes substantially parallel to the direction of the main airflow flowing from the fan 15 to the face-duct opening 23. In this manner, the air flows more smoothly toward the face-duct opening 23, and thereby the pressure loss becomes smaller. In case an amount of air required to be blown from the face-duct opening 23 is not much different from an amount of air required to be blown from the foot-duct opening 25, the louver may be formed, so that it becomes substantially parallel to the main airflow toward the foot-duct opening 25. The louver may be differently angled between its positions closer to the face-duct opening 23 and closer to the foot-duct opening 25.

Though the evaporator 19 composed of the flat tubes 19f and the corrugated fins 19g is used in the foregoing embodiments, it is also possible to use an evaporator having no fin. Also, a plate-fin-type evaporator (composed of thin aluminum plates having louvers thereon and aluminum pipes inserted into the plates) may be used.

If the required air volume is not much different between the face-duct opening 23 and the foot-duct opening 25, an air guide may be disposed in the outlet air passage 18 to increase an airflow toward the foot-duct opening 25.

While the present invention has been shown and described with reference to the foregoing preferred embodiments, it will be apparent to those skilled in the art that changes in form and detail may be made therein without departing from the scope of the invention as defined in the appended claims.

What is claimed is:

1. An automotive air-conditioner comprising:
an air-conditioner case;
a blower unit having a scroll casing containing a centrifugal fan therein, the scroll casing having a scroll angle starting from a scroll-starting position and ending at a scroll-ending position, the blower unit being disposed in the air-conditioner case;
a plurality of outlet ducts disposed downstream of the blower unit in the air-conditioner case, some outlet ducts requiring a larger amount of air to be blown therefrom than other ducts;
an air passage formed in the air-conditioner case from the centrifugal fan to the outlet ducts; and
mode-switching doors for closing and opening the respective outlet ducts in a controlled manner, wherein:
the centrifugal fan is a backward fan having a blade angle larger than 90°; and
the outlet ducts requiring a larger amount of air are positioned closer to the scroll-starting position than the other outlet ducts requiring less amount of air.

2. The automotive air-conditioner as in claim 1, wherein:
the air passage is formed along a surface perpendicular to a rotational axis of the centrifugal fan.

3. The automotive air-conditioner as in claim 1, wherein:
the outlet ducts requiring a larger amount of air are positioned above a tangent line extending from the scroll-ending position.

4. The automotive air-conditioner as in claim 1, wherein:
the outlet ducts requiring a larger amount of air are outlet ducts from which conditioned air to be blown toward a head portion of a passenger is supplied.

5. The automotive air-conditioner as in claim 1, wherein:
the scroll angle of the scroll casing is set to a range from 180° to 290°.

6. The automotive air-conditioner as in claim 1, further including a heat-exchanger for cooling which is disposed downstream of the blower unit.

7. The automotive air-conditioner as in claim 6, further including a heat-exchanger for heating air cooled by the cooling heat-exchanger, the heating heat-exchanger being disposed downstream of the cooling heat-exchanger.

8. The automotive air-conditioner as in claim 6, wherein:
the heat-exchanger for cooling is disposed along an outer periphery of the centrifugal fan.

9. The automotive air-conditioner as in claim 8, wherein:
the heat-exchanger for cooling is composed of a single unit having an arcuate shape.

10. The automotive air-conditioner as in claim 8, wherein:
the heat-exchanger for cooling is composed of a plurality of units each having an rectangular parallelepiped shape.

11. The automotive air-conditioner as in claim 6, wherein:
the heat-exchanger for cooling comprises a plurality of flat tubes laminated to form spaces between flat surfaces of the flat tubes, the spaces forming a main airflow passage; and
the heat-exchanger for cooling is disposed in the air passage so that the flat surfaces of the flat tubes are positioned substantially in parallel to a plane perpendicular to a rotational axis of the centrifugal fan.
